(19) United States
(12) Patent Application Publication
(10) Pub. No.: US 2017/0221058 A1
(43) Pub. Date: Aug. 3, 2017

(54) SYSTEM AND METHOD FOR SECONDARY ACCOUNT HOLDER PAYMENT DEVICE CONTROL

(71) Applicant: VISA INTERNATIONAL SERVICE ASSOCIATION, San Francisco, CA (US)

(72) Inventors: Mohit Choudhary, Bangalore (IN); Prateek Khare, Bangalore (IN); Siddhant Sonkar, Bangalore (IN); Venkata Krishna Prasad Akkapeddi, Bangalore (IN)

(21) Appl. No.: 15/013,830

(22) Filed: Feb. 2, 2016

(51) Int. Cl. G06Q 20/40; G06Q 20/38

(52) U.S. Cl. CPC G06Q 20/405; G06Q 20/382

(57) ABSTRACT

A computer-implemented system and method may allow primary account holders (e.g., parents) to select merchants along specific routes where a secondary account holder (e.g., child) would be able to use a payment device. Each of these merchants may be categorized to further allow a parent to approve or reject purchases with a particular merchant. Any attempt to consummate a financial transaction with such a device at a disallowed merchant or at a merchant outside the defined geo-zone would not go through and may trigger an alert message to the parent/primary account holder (e.g., an email, SMS, phone call, etc.). Furthermore, setting a threshold may enable a trigger to ask the parent for approval in case the child makes a transaction of an amount exceeding the threshold value.

### FIELD OF TECHNOLOGY

The present disclosure relates to a system and method for controlling the use of a secondary account holder's payment device.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Payment devices such as credit cards, linked wallet applications for smartphones, near-field communication (NFC)-enabled wearables, and other devices offer a world of convenience. However, these same devices present a number of challenges for account holders in general and, specifically, for a primary account holder to manage purchases and payments for any secondary account holders. Essentially, the primary account holder must trust the secondary account holder(s) within in the payment ecosystem. While spending limits present the traditional form of control for the primary account holder, there is no robust and secure method for detailed control for the primary account holder over any secondary account holders.

### SUMMARY

Features and advantages described in this summary and the following detailed description are not all-inclusive. Many additional features and advantages will be apparent to one of ordinary skill in the art in view of the drawings, specification, and claims hereof. Additionally, other embodiments may omit one or more (or all) of the features and advantages described in this summary.

Many secondary account holders are children of the primary account holders. A computer-implemented “child mode” for a payment device may make purchases and payments with child secondary account holder devices simple and secure while also giving sufficient access to the parents to enable the appropriate use of these payment devices.

A computer-implemented system and method may allow primary account holders (e.g., parents) to select merchants along specific routes where a secondary account holder (e.g., child) would be able to use a payment device. Each of these merchants may be categorized to further allow a parent to approve or reject purchases with a particular merchant. Any attempt to consummate a financial transaction with such a device at a disallowed merchant or at a merchant outside the defined geo-zone would not go through and may trigger an alert message to the parent/primary account holder (e.g., an email, SMS, phone call, etc.). Furthermore, setting a threshold may enable a trigger to ask the parent for approval in case the child makes a transaction of an amount exceeding the threshold value.

In some embodiments, a secondary account holder payment device control system may include a payment processing server and a point of sale server. A payment processing server may receive geographic parameters corresponding to a geographic area represented on a map. The payment processing server may also receive merchant parameters indicating which of a plurality of merchants located within the geographic area are allowed to receive payment for a transaction using a secondary account holder payment device. The geographic parameters and merchant parameters may correspond to a primary account holder data profile. A point of sale server may send transaction data to the payment processing server. The transaction data may include location data for the transaction, and a token indicating the primary account holder data profile. In response to comparing the received transaction data to the received geographic parameters and merchant parameters, the payment processing server may either approve or deny the payment for the transaction.

In further embodiments, a computer-implemented method may control a secondary account holder payment device. The method may receive geographic parameters corresponding to a geographic area represented on a map and also receive merchant parameters indicating which of a plurality of merchants located within the geographic area are allowed to receive payment for a transaction using a secondary account holder payment device. The method may also compare transaction data from a merchant to the received geographic parameters and the received merchant parameters. In response to comparing the transaction data to the received geographic parameters and the received merchant parameters, the method may then one of approve or deny payment for a transaction corresponding to the transaction data.

### BRIEF DESCRIPTION OF THE DRAWINGS

FIG. 1 illustrates a system for detailed control of purchases using a payment device for a secondary account holder;

FIG. 2A and FIG. 2B illustrate a first exemplary payment device for use with the system for detailed control of purchases using the first exemplary payment device for the secondary account holder;

FIG. 2C and FIG. 2D illustrate a second exemplary payment device for use with the system for detailed control of purchases using the second exemplary payment device for the secondary account holder;

FIG. 3A and FIG. 3B illustrate a process flow for detailed control of purchases using a payment device for a secondary account holder;

FIGS. 4A and 4B illustrate exemplary interfaces for defining parameters for allowable transactions using the secondary account holder payment device; and

FIG. 5 illustrates a computing device used within the system for detailed control of purchases using a payment device for a secondary account holder and to implement the various process flows or methods described herein.

The figures depict a preferred embodiment for purposes of illustration only. One skilled in the art may readily recognize from the following discussion that alternative embodiments of the structures and methods illustrated herein may be employed without departing from the principles described herein.

### DETAILED DESCRIPTION

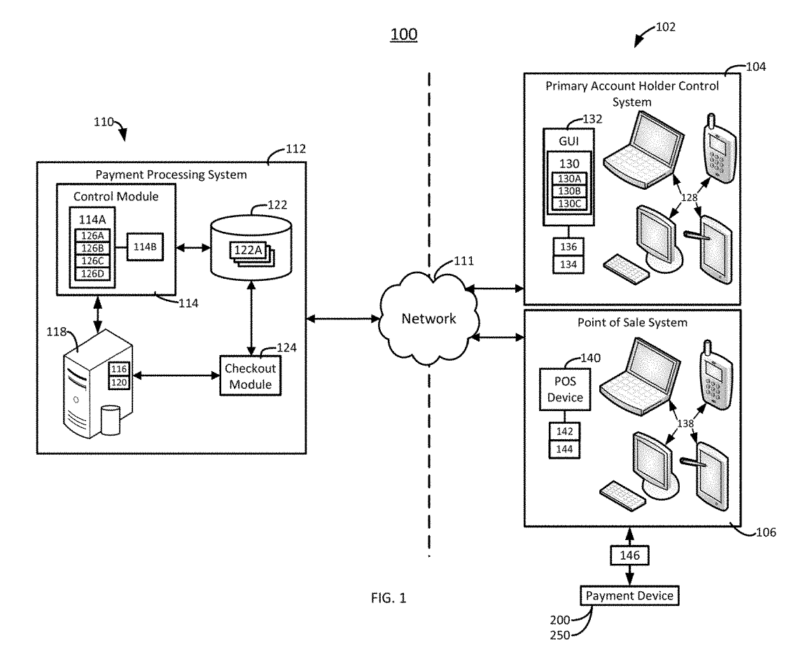

FIG. 1 generally illustrates one embodiment of a system 100 for detailed control of purchases using a payment device for a secondary account holder as described herein. The system 100 may include front end components 102 (e.g., a primary account holder control system 104, a point of sale system 106, a payment device 108, etc.) and backend components 110 (e.g., a payment processing system 112). The front end components 102 and backend components 110 may be in communication with each other via a communication link 111 (e.g., computer network, internet connection, etc.). The system 100 may include various software or computer-executable instructions and specialized hardware components or modules that employ the software and instructions to provide a primary account holder with detailed control of purchases using a payment device for a secondary account holder as described herein. The various modules may be implemented as computer-readable storage memories containing computer-readable instructions (i.e., software) for execution by a processor of the computer system 100 within a specialized or unique computing device. The modules may perform the various tasks associated with providing the primary account holder with detailed control of purchases using a payment device for a secondary account holder as described herein. The computer system 100 may also include both hardware and software applications, as well as various data communications channels for communicating data between the various specialized or unique front end 102 and back end 110 hardware and software components.

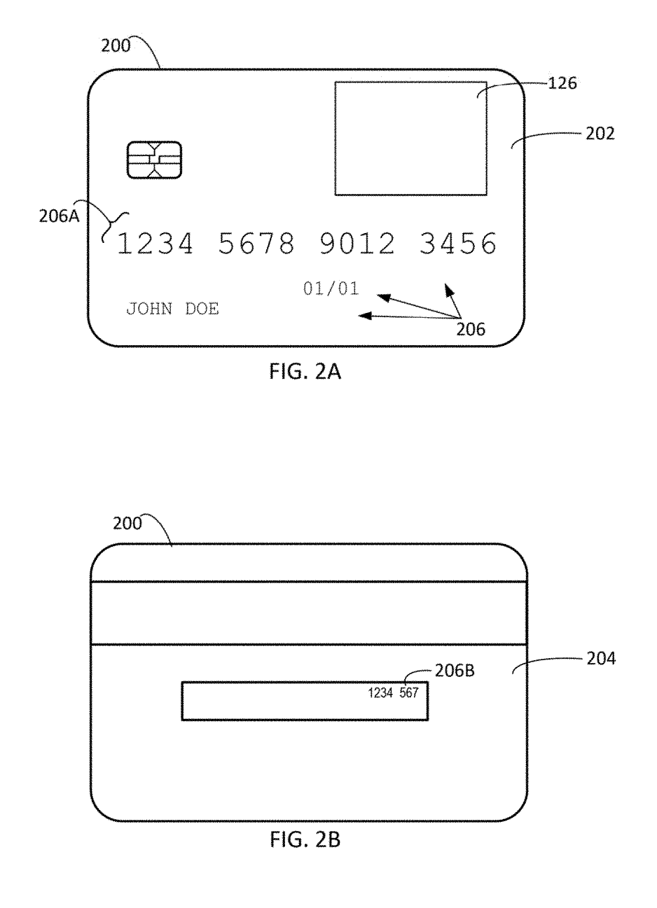

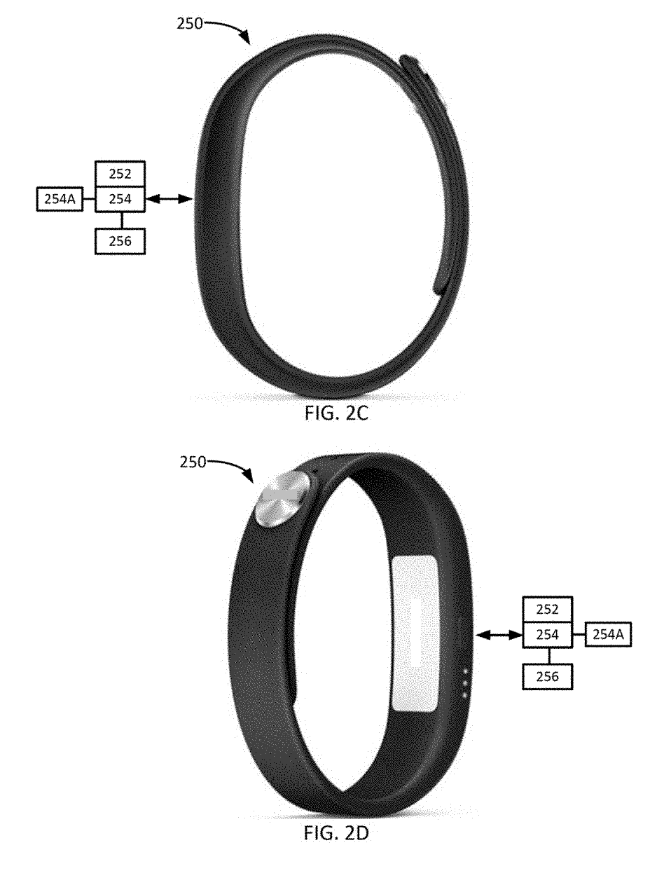

The payment processing system 112 may include one or more instruction modules including a control module 114 that, generally, may include instructions to cause a processor 116 of a payment processing server 118 to functionally communicate with a plurality of other computer-executable steps or modules 114A, 114B, and 114C. These modules 114, 114A-C may include instructions that, upon loading into the server memory 120 and execution by one or more computer processors 116, provide a primary account holder with detailed control of purchases using a payment device 200, 250 (FIGS. 2A, 2B, 2C, and 2D) for a secondary account holder as described herein. A data repository 122 may include primary account holder data profiles 122A that each include various pieces of data to describe an account of a primary account holder and user of the payment processing system 112. This data 122A may be embodied within the payment device 200, 250 as described herein. With brief reference to FIGS. 2A and 2B, a first exemplary payment device 200 (FIGS. 2A and 2B) and a second exemplary payment device 250 (FIGS. 2C and 2D) may take on a variety of shapes and forms. In some embodiments, the first payment device 200 is a traditional card such as a debit card or credit card. In other embodiments, the second payment device 250 may be a fob on a key chain, an NFC wearable, or other device. As long as the payment device 200, 250 is able to communicate securely with a point of sale system, 106, the form of the payment device 200, 205 may not be especially critical and may be a design choice. For example, many legacy payment devices may have to be read by a magnetic stripe reader and thus, the first payment device 200 may have to be sized to fit through a magnetic card reader. In other examples, the second payment device 250 may communicate through near field communication and the form of the second payment device 250 may be virtually any form. Of course, other forms may be possible based on the use of the card, the type of reader being used, etc.

Physically, the first payment device 200 may be a card and the card may have a plurality of layers to contain the various elements that make up the payment device 200. In one embodiment, the payment device 200 may have a substantially flat front surface 202 and a substantially flat back surface 204 opposite the front surface 202. Logically, in some embodiments, the faces 202, 204 may have some embossments 206 including a Primary Account Number (“PAN”) 206A and a Card Verification number (“CVN”) 206B.

The second payment device 250 (FIGS. 2C and 2D) may include a near-field communication “wearable” device having a processor 252, memory 254, payment module 254A stored in the memory 254, and a communication interface 256. The payment module 254A may include instructions that, upon execution by the processor 252, facilitate transmitting payment information to a point-of-sale system 106 and on to the payment processing system 112 via the network 111. In some embodiments, the module 254A includes data corresponding to the primary account holder, such as a primary account holder data profile 122A for the primary account holder. The memory 254 generally and the module 254A in particular may be encrypted such that all data related to payment is secure from unwanted third parties. The communication interface 256 may include instructions to facilitate sending payment information or a token to identify payment information to the point-of-sale system 106, which then passes the payment data/token to the payment processing system 112 via the network 111.

Returning to FIG. 1, a checkout module 124 may include various instructions that, upon execution by the processor 116, facilitate a user employing a payment device 200, 250 for a financial transaction. The module 124 may include instructions that, upon loading into the server memory 120 and execution by one or more computer processors 116, allow the user to employ the payment device 200, 250 and his or her corresponding account data 122A to complete a payment using, for example, the PAN 206A and other data from the payment device and also coordinate with the control module 114 to detailed control of any payments made using the device 200, 250 as described herein. In some embodiments, the checkout module 124 may include instructions to process payments or other transaction data 146 during an in-person or online financial transaction between a secondary account holder and a merchant using the payment device 200, 250 and point-of-sale system 106, respectively. For example, the module 124 may include instructions to access account data 122A corresponding to the primary account holder for the payment device 200, 250 used in the transaction and approve or deny the transaction according to the parameters 126A, 126B, 126C, and 126D defined by the control module 114 via the network 111 and using the transaction data 146. As further explained below, the parameters may include route parameters 126A, merchant parameters 126B, threshold parameters 126C, and a various other parameters (e.g., time limit, time of day thresholds, number of transactions limit, etc.) 126D. The module 124 may also call one or more APIs of the control module 114 (e.g., a messaging module 114B) send a message to the primary account holder via the network 111 to the primary account holder control system 104.

The control module 114 may also include instructions to coordinate execution of other instructions by the primary account holder control system 104 to create the parameters 126A, 126B, 126C, and 126D. For example, a parameter module 114A may include instructions to cause an application executing on a primary account holder computing device 128 to display a control interface 130 within a Graphic User Interface (“GUI”) 132 of the user computing device 128. In some embodiments, the GUI 132 may include a browser or other application stored in a memory 134 and executed on a processor 136 of the computing device 128 to display the control interface 130. The control interface 130 may include several elements including a route or map planner interface 130A, an approved merchant selector interface 130B, a threshold setting interface 130C, and other modules to configure the various parameters 126A, 126B, 126C, and 126D using the GUI 132 to allow the primary account holder to control payment and other financial transactions by a secondary account holder, as described herein. In some embodiments, the route planner interface 130A includes access to an on-line mapping system API such as Google® Maps, Apple® Maps, etc.

A messaging module 114B may include instructions to send a message to the primary account holder computing device 128 upon any condition set by the control interface 130 within a Graphic User Interface (“GUI”) 132 of the user computing device 128. In some embodiments, the module may configure one or more messages upon receiving an indication of a payment event or other financial transaction data 146 using the payment device 200, 250 that is not authorized by the primary account holder via the control interface 130. For example, the module 114B may include an instruction that, upon execution by the processor 116, sends or causes an SMS, e-mail, voicemail, or other message to be sent to the primary account holder computing device 128 indicating an unauthorized use upon receiving an indication that the payment device 200, 250 was attempted to be used at an unauthorized merchant or other unauthorized use at a point of sale system 106.

The point of sale system 106 includes a point-of-sale computing device 138 in communication with a point-of-sale (POS) device having a processor 142 and memory 144. The POS device 140 may include instructions that are stored in the memory 144 and executed by the processor 142 to send payment information to the payment processing system 112 via the network 111. In some embodiments, the system 106 may send a primary account number (PAN) or other data from the payment device 200, 250 to system 112 along with identifying information about the merchant, location, or other data to facilitate the payment control features described herein. The system 106 may also authenticate a consumer as the owner of a particular payment device 200, 250, used in the transaction as indicated by the transaction data 146.

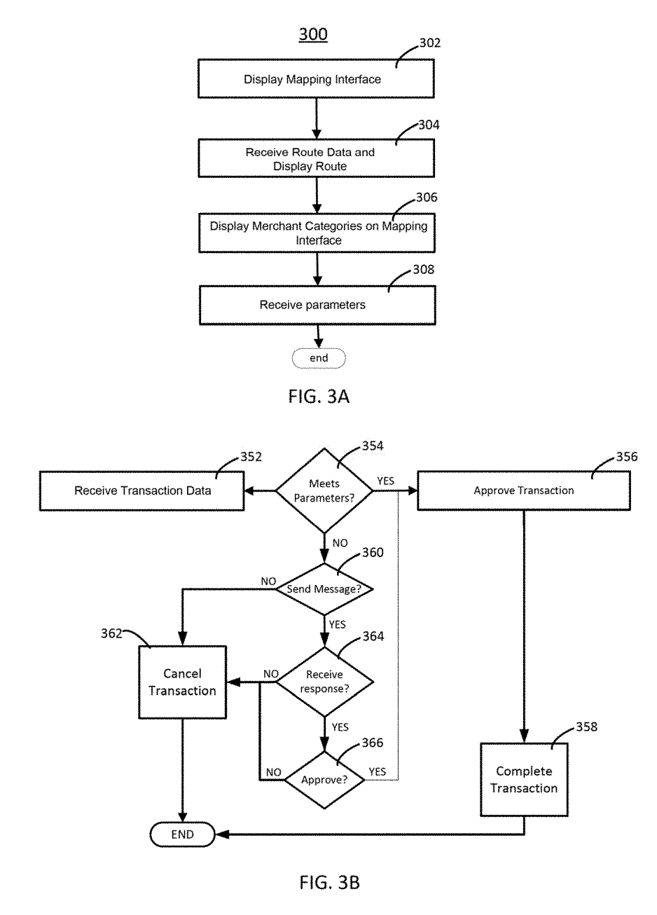

With reference to FIGS. 3A and 3B, the system 100, generally, and processors 116, 136, 142 of the payment processing server 118, primary account holder control system 104, and/or point-of-sale system 106, respectively, described herein may execute methods 300, 350 to control the use of a secondary account holder's payment device 200, 250. Each various “step” described herein may correspond to one or more computer-executable instructions of the modules of the system 100 as executed on one or more processors such as processors 116, 136, and 142.

More than just being methods 300, 350 which block payment cards in specific zones, the methods 300, 350 may allow a primary account holder using the primary account holder control system 104 to select specific routes along which particular merchants or categories of merchants are approved for a payment transaction by a secondary account holder and the rest disapproved. For example, a secondary account holder is primarily located in one of two proximities: A—HOME and B—SCHOOL. The method may select the road that is used by the secondary account holder for commuting daily between A and B and then populates this route with all the merchants existing along it. Since these merchants are categorized, the primary account holder then has an option of enabling or disabling any specific merchant or category of merchants for a payment transaction. Further, the methods 300, 350 may allow the primary account holder to set the maximum spending amount for the secondary account holder. Where the secondary account holder exceeds the spending threshold or any other threshold set by the primary account holder (e.g., time limits, location limits, time of day, etc.), a payment transaction above these set thresholds would require an approval from the primary account holder. The methods 300, 350 may then initiate an SMS or other communication process to notify and begin an approval process, if desired. Setting specific access routes and threshold values for the payment device also helps reduce any chance of fraud.

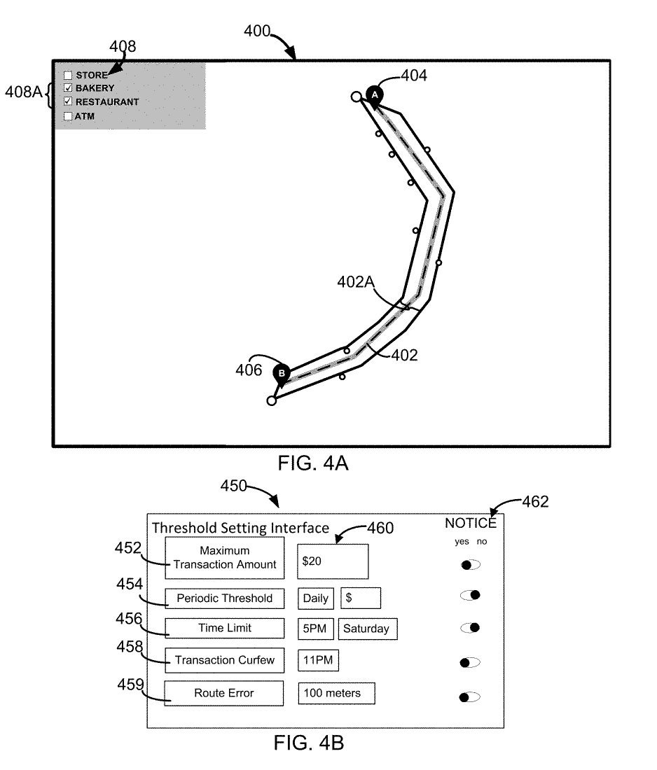

With reference to FIG. 3A, an initialization method 300 may allow a primary account holder to set a number of parameters to control the transaction of a secondary account holder. At step 302, the method 300 may cause one or more processors to execute instructions to display the control interface 130 within a GUI 132 of a primary account holder computing device 128 in response to a request from the device 128. In some embodiments, step 302 may include instructions to display a mapping interface 400 (FIG. 4A).

At 304, the method 300 may cause one or more processors to execute instructions to receive route data and, in response, display a route 402 between two locations 404 and 406. With reference to FIG. 4A, the route 402 may include an allowable zone 402A that is a configurable distance around the route 402. The method 300 may also store the received route data as a plurality of geographic route parameters 126A. In some embodiments, the route 402 may include, alone or in any combination, a path between two or more geographic locations that may be represented on a map, an area around one or more map points, a configurable regular or irregularly-shaped area around one or more map points, or any other geographic point or area that may be defined on a map.

At 306, the method 300 may cause one or more processors to execute instructions to display a list of merchant categories 408 that are located within the map area. The method 300 may then receive a primary account holder selection of one or more allowed merchants or merchant categories 408A and display those merchants within the mapping interface 400 along the route 402. The method 300 may also store the received merchant data as the merchant parameters 126B.

At 308, the method 300 may cause one or more processors to execute instructions to receive threshold parameters 126C from a threshold setting interface 130C. In some embodiments, the threshold setting interface 130C may be displayed as the interface 450 of FIG. 4B. The threshold setting interface 130C may cause threshold data to be sent to the payment processing system 112 via the network 111. In some embodiments, the threshold parameters 126C include a maximum transaction amount 452, a periodic threshold 454 (e.g., a daily, weekly, monthly, etc., spending limit), a time limit 456 (e.g., the payment device 200, 250 may only be used until 5 PM on the following Saturday or by another configurable date or time, etc.), a transaction curfew 458 (e.g., transactions with the payment device 200, 250 are not permitted after a configurable time of day, date, or other limit), a route error 459 (e.g., a configurable distance threshold from the route), and other parameters. The interface 450 may also include a number of entry boxes 460 to enter amounts as well as configurable notice selectors 462. The notice selectors 462 may cause one or more processors to execute instructions to send a message to the primary account holder regarding an attempted transaction by the secondary account holder that exceeds one of the threshold parameters 452, 454, 456, 458, 459. Once the parameters are received, the method 300 may end.

With reference to FIG. 3B, a payment control method 350 may allow the system 100 to control use of the secondary account holder's payment device 200, 250 in accordance with the parameters described above in relation to the system 100 and the method 300. At step 352, the method 350 may cause one or more processors to execute instructions to receive, at the payment processing system 112, transaction data 146 or an indication of the transaction data 146 from the secondary account holder's payment device 200, 250, via the point of sale system 106 and the network 111. The transaction data 146 may include various data points to compare against the various parameters 126A, 126B, 126C, 126D, and threshold parameters 452, 454, 456, 458, and 459, as described herein. For example, the transaction data 146 may include a transaction amount, a merchant location, a payment device location, a date, a time of day, or other data that may be compared to the various parameters 126A, 126B, 126C, 126D, and threshold parameters 452, 454, 456, 458, and 459.

At step 354, the method 350 may cause one or more processors to execute instructions to compare the received transaction data 146 to the various parameters 126A, 126B, 126C, 126D, and threshold parameters 452, 454, 456, 458, and 459 to determine if the parameters have been met. For example, the one or more processors may execute instructions to: determine whether transaction data 146 indicates a payment device 200, 250 and/or merchant location within the route parameters 126A or within a route error distance 459 of the route; determine whether the transaction data 146 indicates a merchant that has been identified as approved by the primary account holder for transactions within the merchant parameters 126B; determine whether the transaction data 146 includes a time, date, or other data that is within the threshold parameters 126C, 452, 454, 456, 458; or other determinations.

If the transaction data 146 meets the various parameters 126A, 126B, 126C, 126D, and threshold parameters 452, 454, 456, 458, and 459, then the method 350 may cause one or more processors to execute instructions to approve the transaction at step 356. The method 350 may then cause one or more processors to execute instructions to complete the transaction at step 358 (e.g., cause the payment processing system 112 to send a confirmation code to the point-of-sale system 106, etc.), and the method 350 may end.

If the transaction data 146 does not meet the various parameters 126A, 126B, 126C, 126D, and threshold parameters 452, 454, 456, 458, and 459, then the method 350 may cause one or more processors to determine whether to send a confirmation request at step 360. In some embodiments, the method 350 may cause one or more processors to execute instructions to determine whether a notice selector 462 indicated to send the message based on the particular parameters that were not met. If a notice selector 462 was not indicated as “yes” for any of the parameters that were not met at step 354, then the method 350 may proceed to step 362. At step 362, the method 350 may cause one or more processors to cancel the transaction. In some embodiments, the method 350 may cause one or more processors to send a cancellation to the point-of-sale system 106 that sent the transaction data at step 352.

If a notice selector 462 was indicated as “yes” for any of the parameters that were not met at step 354, then the method 350 may cause one or more processors to send an exceeded threshold message (e.g., SMS, e-mail, voicemail, etc.) from the payment processing system 112 to the primary account holder control system 104 or the computing device 128 and proceed to step 364. The message sent from the payment processing system 112 may include an indication of which of the various parameters 126A, 126B, 126C, 126D, and threshold parameters 452, 454, 456, 458, and 459 were not met at step 354. For example, the message may state “Bobby has attempted to use his payment device at the bakery for a transaction of $30, which exceeds the limit you set for him by $10. To approve this transaction, reply ‘yes’ or to deny the transaction, reply ‘no.’” The method 350 may also cause one or more processors to execute instructions to send a similar message to the secondary account holder informing him/her that a parameter was not met or exceeded and a message was sent to the primary account holder.

At step 364, the method 350 may cause one or more processors to execute instructions to determine whether a confirmation message was received by the payment processing system 112 from the primary account holder control system 104 via the network 111 in response to the message sent at step 360. In some embodiments, the confirmation message may include an SMS response of “yes” or “no.” If the method 350 does not receive a response and time limit is reached, the method 350 may cause one or more processors to execute instructions to proceed to step 362. Similarly, if the method 350 receives a response at step 364, but the method 350 determines that the response does not approve the transaction at step 366, then the method 350 may cause one or more processors to execute instructions to cancel the transaction at step 362. If, at step 366, the system 100 receives a “yes” response, then the method 350 may cause one or more processors to execute instructions to approve the transaction at step 356 and complete the transaction at step 358, and end.

In some embodiments, the system may have a learning aspect. For example, if the system 100 has received a “yes” response previously based on the various parameters 126A, 126B, 126C, 126D, and threshold parameters 452, 454, 456, 458, the system 100 may not request approval of the transaction again if the same parameters 126A, 126B, 126C, 126D and threshold parameters 452, 454, 456, 458 exist. In a real world example, if a purchase at a known bakery at a known location for a known amount has been approved previously, the same transaction may be approved automatically based on the previous approval.

Further, the learning aspect may take into account specific parameters more than other parameters. The learning algorithm which may operate on a learning server which may have a processor specifically adapted to operate the learning algorithm may notice that a particular user approves all transactions under $9 dollars. Thus, the method may refrain from asking for permission for transactions under $9 as long as the transaction is within a reasonable range of the other parameters. For example, a purchase of $8 in another country would require that approval be solicited.

The system may also users to add weights to parameters or weights may be determined by the algorithm. The weights may be used by the learning algorithm in determining whether to pursue permission for a transaction. As an example, location may be given a large weight as a transaction from an unknown location is likely to be rejected. At the same time, the type of item being purchase may be given a lower weight as the user may view the type of item purchased as being unimportant as long as the location and dollar amount are acceptable.

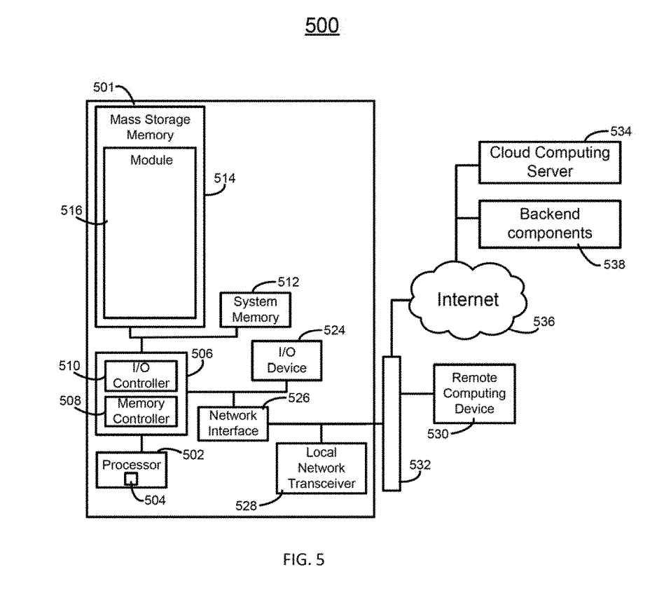

FIG. 5 is a high-level block diagram of an example computing environment 500 for the system and methods for controlling the use of a payment device as described herein. The computing device 501 may include a server (e.g., the payment processing server 118, etc.), a mobile computing device (e.g., the primary account holder computing device 128, the point-of-sale computing device 138, a cellular phone, a tablet computer, a Wi-Fi-enabled device or other personal computing device capable of wireless or wired communication), a thin client, or other known type of computing device. As will be recognized by one skilled in the art, in light of the disclosure and teachings herein, other types of computing devices can be used that have different architectures. Processor systems similar or identical to the example systems and methods for controlling the use of a payment device may be used to implement and execute the example systems of FIG. 1. Although the example system 500 is described below as including a plurality of peripherals, interfaces, chips, memories, etc., one or more of those elements may be omitted from other example processor systems used to implement and execute the example system for a primary account holder to control the use of a secondary account holder's payment device. Also, other components may be added.

As shown in FIG. 5, the computing device 501 includes a processor 502 that is coupled to an interconnection bus. The processor 502 includes a register set or register space 504, which is depicted in FIG. 5 as being entirely on-chip, but which could alternatively be located entirely or partially off-chip and directly coupled to the processor 502 via dedicated electrical connections and/or via the interconnection bus. The processor 502 may be any suitable processor, processing unit or microprocessor. Although not shown in FIG. 5, the computing device 501 may be a multi-processor device and, thus, may include one or more additional processors that are identical or similar to the processor 5402 and that are communicatively coupled to the interconnection bus.

The processor 502 of FIG. 5 is coupled to a chipset 506, which includes a memory controller 508 and a peripheral input/output (I/O) controller 510. As is well known, a chipset typically provides I/O and memory management functions as well as a plurality of general purpose and/or special purpose registers, timers, etc. that are accessible or used by one or more processors coupled to the chipset 506. The memory controller 508 performs functions that enable the processor 5402 (or processors if there are multiple processors) to access a system memory 512 and a mass storage memory 514, that may include either or both of an in-memory cache (e.g., a cache within the memory 512) or an on-disk cache (e.g., a cache within the mass storage memory 514).

The system memory 512 may include any desired type of volatile and/or non-volatile memory such as, for example, static random access memory (SRAM), dynamic random access memory (DRAM), flash memory, read-only memory (ROM), etc. The mass storage memory 514 may include any desired type of mass storage device. For example, if the computing device 501 is used to implement a module 516 (e.g., the various modules to control a secondary account holder's use of a payment device and other modules as herein described). The mass storage memory 514 may include a hard disk drive, an optical drive, a tape storage device, a solid-state memory (e.g., a flash memory, a RAM memory, etc.), a magnetic memory (e.g., a hard drive), or any other memory suitable for mass storage. As used herein, the terms module, block, function, operation, procedure, routine, step, and method refer to tangible computer program logic or tangible computer executable instructions that provide the specified functionality to the computing device 501 and the system 100. Thus, a module, block, function, operation, procedure, routine, step, and method can be implemented in hardware, firmware, and/or software. In one embodiment, program modules and routines are stored in mass storage memory 514, loaded into system memory 512, and executed by a processor 502 or can be provided from computer program products that are stored in tangible computer-readable storage mediums (e.g. RAM, hard disk, optical/magnetic media, etc.).

The peripheral I/O controller 510 performs functions that enable the processor 502 to communicate with a peripheral input/output (I/O) device 524, a network interface 526, a local network transceiver 528, (via the network interface 526) via a peripheral I/O bus. The I/O device 524 may be any desired type of I/O device such as, for example, a keyboard, a display (e.g., a liquid crystal display (LCD), a cathode ray tube (CRT) display, etc.), a navigation device (e.g., a mouse, a trackball, a capacitive touch pad, a joystick, etc.), etc. The I/O device 524 may be used with the module 516, etc., to receive data from the transceiver 528, send the data to the backend components of the system 100, and perform any operations related to the methods as described herein. The local network transceiver 528 may include support for a Wi-Fi network, Bluetooth, Infrared, or other wireless data transmission protocols. In other embodiments, one element may simultaneously support each of the various wireless protocols employed by the computing device 501. For example, a software-defined radio may be able to support multiple protocols via downloadable instructions. In operation, the computing device 501 may be able to periodically poll for visible wireless network transmitters (both cellular and local network) on a periodic basis. Such polling may be possible even while normal wireless traffic is being supported on the computing device 501. The network interface 526 may be, for example, an Ethernet device, an asynchronous transfer mode (ATM) device, an 802.11 wireless interface device, a DSL modem, a cable modem, a cellular modem, etc., that enables the system 100 to communicate with another computer system having at least the elements described in relation to the system 100.

While the memory controller 508 and the I/O controller 510 are depicted in FIG. 5 as separate functional blocks within the chipset 506, the functions performed by these blocks may be integrated within a single integrated circuit or may be implemented using two or more separate integrated circuits. The computing environment 500 may also implement the module 516 on a remote computing device 530. The remote computing device 530 may communicate with the computing device 501 over an Ethernet link 532. In some embodiments, the module 516 may be retrieved by the computing device 501 from a cloud computing server 534 via the Internet 536. When using the cloud computing server 534, the retrieved module 516 may be programmatically linked with the computing device 501. The module 516 may be a collection of various software platforms including artificial intelligence software and document creation software or may also be a Java® applet executing within a Java® Virtual Machine (JVM) environment resident in the computing device 501 or the remote computing device 530. The module 516 may also be a “plug-in” adapted to execute in a web-browser located on the computing devices 501 and 530. In some embodiments, the module 516 may communicate with back end components 538 such as the backend components 110 of FIG. 1 via the Internet 536.

The system 500 may include but is not limited to any combination of a LAN, a MAN, a WAN, a mobile, a wired or wireless network, a private network, or a virtual private network. Moreover, while only one remote computing device 530 is illustrated in FIG. 5 to simplify and clarify the description, it is understood that any number of client computers are supported and can be in communication within the system 500.

Additionally, certain embodiments are described herein as including logic or a number of components, modules, or mechanisms. Modules may constitute either software modules (e.g., code or instructions embodied on a machine-readable medium or in a transmission signal, wherein the code is executed by a processor) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common use, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments” or “an embodiment” or “teaching” means that a particular element, feature, structure, or characteristic described in connection with the embodiment is included in at least one embodiment. The appearances of the phrase “in some embodiments” or “teachings” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

Further, the figures depict preferred embodiments for purposes of illustration only. One skilled in the art will readily recognize from the following discussion that alternative embodiments of the structures and methods illustrated herein may be employed without departing from the principles described herein

Upon reading this disclosure, those of skill in the art will appreciate still additional alternative structural and functional designs for the systems and methods described herein through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the systems and methods disclosed herein without departing from the spirit and scope defined in any appended claims.

1. A secondary account holder payment device control system comprising:
a payment processing server for receiving geographic parameters corresponding to a geographic area represented on a map and receiving merchant parameters indicating which of a plurality of merchants located within the geographic area are allowed to receive payment for a transaction using a secondary account holder payment device, wherein the geographic parameters and merchant parameters correspond to a primary account holder data profile;
a point of sale server for sending transaction data to the payment processing server, the transaction data including location data for the transaction, and a token indicating the primary account holder data profile;
wherein, in response to comparing the received transaction data to the received geographic parameters and merchant parameters, the payment processing server either approves or denies the payment for the transaction.

2. The system of claim 1, wherein the geographic parameters include one or more of a path between two or more geographic locations, an area around one or more geographic locations, and an area around one or more geographic locations.

3. The system of claim 1, wherein the merchant parameters include one or more categories of merchants.

4. The system of claim 1, further comprising a primary account holder server for displaying a route planner interface and a threshold setting interface at a primary account holder computing device.

5. The system of claim 4, wherein the primary account holder server is further for sending the geographic parameters to the payment processing server from the route planner interface.

6. The system of claim 4, wherein the primary account holder server is further for sending the merchant parameters to the payment processing server from the threshold setting interface.

7. The system of claim 1, wherein the payment processing server is further for receiving a threshold parameter including one or more of a maximum transaction amount, a period threshold, a time limit, a transaction curfew, and a route error.

8. The system of claim 1, wherein the secondary account holder payment device includes one or more of a credit card or an NFC-enabled wearable.

9. The system of claim 1, wherein the payment processing server is further for sending a message to a primary account holder computing device in response to denying the payment for the transaction.

10. The system of claim 9, wherein the payment processing server is further for configuring the message to include data to approve or deny the payment for the transaction.

11. A computer-implemented method for controlling a secondary account holder payment device, the method comprising:
receiving geographic parameters corresponding to a geographic area represented on a map;
receiving merchant parameters indicating which of a plurality of merchants located within the geographic area are allowed to receive payment for a transaction using a secondary account holder payment device;
comparing transaction data from a merchant to the received geographic parameters and the received merchant parameters; and
one of approving or denying payment for a transaction corresponding to the transaction data in response to comparing the transaction data to the received geographic parameters and the received merchant parameters.

12. The computer-implemented method of claim 11, wherein the geographic parameters include one or more of a path between two or more geographic locations, an area around one or more geographic locations, and an area around one or more geographic locations.

13. The computer-implemented method of claim 11, wherein the merchant parameters include one or more categories of merchants.

14. The computer-implemented method of claim 11, further comprising displaying a route planner interface and a threshold setting interface at a primary account holder computing device.

15. The computer-implemented method of claim 14, further comprising receiving the geographic parameters at a payment processing server from the route planner interface.

16. The computer-implemented method of claim 14, further comprising receiving the merchant parameters at a payment processing server from the threshold setting interface.

17. The computer-implemented method of claim 11, further comprising receiving a threshold parameter at a payment processing server from the threshold setting interface, the threshold parameter including one or more of a maximum transaction amount, a period threshold, a time limit, a transaction curfew, and a route error.

18. The computer-implemented method of claim 11, wherein the secondary account holder payment device includes one or more of a credit card or an NFC-enabled wearable.

19. The computer-implemented method of claim 11, further comprising sending a message to a primary account holder computing device in response to denying the payment for the transaction.

20. The computer-implemented method of claim 19, further comprising configuring the message to include data to approve or deny the payment for the transaction.
